(19) United States
(12) Patent Application Publication
(10) Pub. No.: US 2014/0266003 A1
(43) Pub. Date: Sep. 18, 2014

(54) CELL BALANCING THROUGH A SWITCHED CAPACITOR LEVEL SHIFTER

(71) Applicant: Atieva, Inc., (US)

(72) Inventor: Richard J. Biskup, Redwood City, CA (US)

(73) Assignee: Atieva, Inc., Redwood City, CA (US)

(21) Appl. No.: 13/835,170

(22) Filed: Mar. 15, 2013

(51) Int. Cl. H02J 7/00

(52) U.S. Cl. CPC H02J 7/0042
USPC 320/103; 320/127; 320/128; 327/306

(57) ABSTRACT

A battery management apparatus is provided. The battery management apparatus includes a switched capacitor level shifter having a first port and a second port. The first port is configured to couple to a cell in a battery stack and the second port is configured to couple to a voltage measurement device. The apparatus includes a discharge device coupled to the second port, wherein the discharge device is configured to discharge the cell via the switched capacitor level shifter. A method of managing a battery stack is also included.

### BACKGROUND

Passive balancing of cells in a battery stack involves discharging one or more of the cells (sinking of current) until the cells approximately match state of charge. Passive balancing may require a voltage shift and attendant circuitry to be able to control the switches that control balance resisters, as a result of the higher voltages developed in battery stacks. Active balancing of cells in a battery stack involves charging one or more of the cells (sourcing of current), usually by drawing charge or energy from the most charged cell or from the entire battery, until the cells approximately match state of charge. Charge or energy transfer, in battery balancing, can be cell-to-battery, battery-to-cell or bidirectional. Since electronic circuitry is usually repeated for each cell or group of cells, and since discrete components are often used in the circuits, the number of discrete components can grow quite large in battery management systems.

It is within this context that the embodiments arise.

### SUMMARY

In one embodiment, a battery management apparatus is provided. The battery management apparatus includes a switched capacitor level shifter having a first port and a second port. The first port is configured to couple to a cell in a battery stack and the second port is configured to couple to a voltage measurement device. The apparatus includes a discharge device coupled to the second port, wherein the discharge device is configured to discharge the cell via the switched capacitor level shifter.

In another embodiment, a battery management apparatus is provided. The apparatus includes a bi-directional, switched capacitor level shifter configured to couple a first end of the switched capacitor level shifter to one of a plurality of cells in a battery stack and a voltage measurement device coupled to a second end of the switched capacitor level shifter. The apparatus includes a pullup switch coupled to the second end of the switched capacitor level shifter and a pulldown switch coupled to the second end of the switched capacitor level shifter.

In yet another embodiment, a method of managing a battery is provided. The method includes coupling a first capacitor to one of a plurality of cells in a battery stack, with a second capacitor decoupled from the first capacitor and then decoupling the first capacitor from the one of the plurality of cells. The method includes coupling the second capacitor to the first capacitor, with the first capacitor decoupled from the one of the plurality of cells and then decoupling the second capacitor from the first capacitor. The method includes measuring a voltage of the second capacitor, in a cell voltage measuring mode and discharging the second capacitor, in a cell discharging mode.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a schematic diagram of a battery management apparatus with a discharge circuit for cell balancing and a switched capacitor level shifter for cell voltage measurement.

FIG. 2 is a schematic diagram of a battery management apparatus with a switched capacitor level shifter, a discharge circuit and a charging circuit, in accordance with the present invention.

FIG. 3 is a schematic diagram of a further embodiment of the battery management apparatus of FIG. 2.

FIGS. 4A-4D are flow diagrams of a methods of battery management, which can be practiced using the battery management apparatus of the embodiments described herein.

### DETAILED DESCRIPTION

The embodiments illustrate various battery management apparatuses and a method relating to operation of the apparatuses. In each of these embodiments, an individual cell in a battery stack can have a cell voltage measured, and the cell can be discharged (partially, for balancing or fully if need be). This application is related to U.S. application Ser. Nos. 13/794,535, ______, ______, ______, and ______ (Attorney Docket Nos. ATVAP123, ATVAP125, ATVAP126, and ATVAP127), each of which is incorporated herein by reference for all purposes.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

In FIG. 1, a battery management apparatus is connected to a battery stack and manages the cells in the stack. A cell balance function employs passive balancing, in that each of Cell 1, Cell 2, Cell 3, Cell 4, and Cell 5 can be discharged independently of the other cells. Cell 5 has a respective balance resistor R5, which may also be referred to as a load resistor. Resistor R5 is coupled in series with a switch S5. The series connected resistor R5 and switch S5 are coupled across Cell 5, i.e., from the positive terminal of Cell 5 to the negative terminal of Cell 5. Activating the switch S5, for example closing the switch or turning on the N type MOSFET (metal oxide semiconductor field effect transistor) that implements the switch in one embodiment, results in discharge current from Cell 5 flowing through the resistor R5 and the switch S5. Customarily, the discharge current is allowed to flow only until the state of charge of the cell approximately matches the state of charge of other cells. State of charge is related to the voltage across the cell, and customarily the voltage across the cell is of interest to the system and is measured in one of a variety of ways. In this example, the cell voltage is measured by a voltage measurement device 102, which could include an analog to digital converter and various ports B0, B1, B2, B3, B4, and B5 coupled to the battery stack. The voltage at Cell 5 is presented across a pair of the ports B5 and B4. It is understood that voltages of other cells are presented at corresponding pairs of the ports. It should be appreciated that each of cells 1-4 may be configured similar to the configuration of cell 5 described herein.

If a high-voltage version of a voltage measurement device is available, the voltage measurement device 102 may be connected directly to the cells in the battery stack, or may be connected through one or more filters. However, in many battery systems, the voltage at the top of the battery stack, i.e., the positive terminal of the battery stack, exceeds the operating voltage range of the voltage measurement device. Voltages at many of the upper cells in the stack may also exceed this range. In such a case, level shifting is utilized to accommodate this aspect of battery stacks. In some embodiments, a switched capacitor level shifter can accomplish this level shifting. In the battery management apparatus of FIG. 1, a switched capacitor level shifter is implemented using two capacitors C1 and C2 and four switches S1a, S2a, S1b, and S2b. These switches can be implemented using relays, bipolar transistors, MOSFETs, mechanical switches or other types of switches. Pairs of the switches S1a, S1b; and S2a, S2b are operated with non-overlapping clocks CLK_1, CLK_2 to alternately couple a first capacitor C1 to Cell 5 or couple the two capacitors C1 and C2 to each other. The second capacitor C2 has one terminal coupled to a local ground. When the first pair of switches S1a and S1b is activated or closed, the cell voltage of Cell 5 is expressed across the first capacitor C1. This is done while the second pair of switches S2a and S2b is deactivated or open. Next, the first pair of switches S1a and S1b is deactivated or opened, while the second pair of switches S2a and S2b remains deactivated or open. During this time, the first capacitor C1 is entirely floating and retains the charge and the voltage that has been impressed upon it (neglecting leakage). Then, the second pair of switches S2a and S2b is activated or closed, while the first pair of switches S1a and S1b remains open or deactivated. This causes the first and second capacitors C1 and C2 to share charge and equalize voltages. The first time this is done, if each of the capacitances of the two capacitors C1 and C2 are approximately equal, the final voltage across both capacitors will be about one half of the voltage originally impressed upon the first capacitor C1. That is, the final voltage will be about one half of the cell voltage. After a number of iterations, the final voltage on the second capacitor C2 will be about equal to the cell voltage, as more and more charge has been transferred onto the second capacitor C2. At that time, the voltage across capacitor C2 can be measured by the voltage measurement device 102. It should be appreciated that the lower terminal of the second capacitor C2 is referenced to local ground, and the absolute voltages of the cell terminals, captured on the first capacitor C1 as a differential voltage across Cell 5, are level shifted down to a ground-referenced voltage seen on the second capacitor C2. This ground-referenced voltage is presentable to the terminals B5 and B4 of the voltage measurement device 102. Without level shifting, the voltage measurement device 102 might be damaged by the higher voltages of Cell 5 resulting from the position of Cell 5 in the battery stack. Use of the non-overlapping clocks CLK_1 and CLK_2 prevents the undesired situation where one of the terminals of the cells could be connected directly to ground. For example, if the lower switch S1b of the first pair of switches and the lower switch S2b of the second pair of switches were both closed at the same time this would short the common terminal between two of the cells, i.e., Cell 4 and Cell 5, directly to local or system ground.

The battery management apparatus of FIG. 2 illustrates an embodiment with the discharge device 202 located on the other side of the switches, as compared to the battery management apparatus of FIG. 1. Also, the battery management apparatus of FIG. 2 adds a charging device 204, coupled to the same side of the switches as the discharge device 202. The discharge device 202 and a charging device 204 act to discharge or charge the second capacitor C2 and balance Cell 5 in an alternative manner to that of the apparatus in FIG. 1. In FIG. 2, a switched capacitor level shifter is implemented using two capacitors C1 and C2 and four switches S1a, S2a, S1b, and S2b. Pairs of the switches S1a, S1b; and S2a, S2b are operated with non-overlapping clocks CLK_1 and CLK_2 to alternately couple a first capacitor C1 to Cell 5 or couple the two capacitors C1 and C2 to each other. It should be appreciated that a non-overlapping clock generator may provide the non-overlapping clocks CLK_1 and CLK_2 in some embodiments. The second capacitor C2 has one terminal coupled to a local or system ground. Here, however, the switched capacitor level shifter can be operated bi-directionally, and can transfer energy and charge in either of two opposing directions. That is, each of two ports of the level shifter can be bidirectional. One port of the level shifter connects to the cell in the battery stack, and can pass current and energy from the cell to the two capacitors C1 and C2, or can pass current and energy from the two capacitors C1 and C2 to the cell. The other port of the level shifter connects to the voltage measurement device 102, in this embodiment via a resistor R5. This second port of the level shifter also connects to a discharge device coupled through a switch or transistor 202 and a charging device coupled through a switch or transistor 204, in this embodiment via the same resistor R5. The second port of the level shifter can pass current and energy from the capacitors C1 and C2 to the discharge device through transistor 202, and can pass current and energy from the charging device through transistor 204 to the two capacitors C1 and C2, as further described below.

The level shifter can transfer energy and charge from Cell 5 to the first capacitor C1 and transfer a portion of this energy and charge from the first capacitor C1 to the second capacitor C2 in a first direction, similar to the operation of the level shifter of FIG. 1. The voltage across the second capacitor C2 can be measured by the voltage measurement device 102, and will approximate the cell voltage after multiple iterations of the couplings and de-couplings of the first and second capacitors C1 and C2. This energy and charge on the second capacitor C2 can also be discharged by the discharge device coupled through transistor 202, which acts to discharge Cell 5 whether or not the voltage across the second capacitor C2 is measured by the voltage measurement device 102.

Additionally, the level shifter in FIG. 2 can transfer energy and charge from the second capacitor C2 to the first capacitor C1, and can transfer a portion of this energy and charge from the first capacitor C1 to Cell 5 in a second direction, as opposed to the operation of the level shifter of FIG. 1. This occurs when the charging device coupled through transistor 204 in FIG. 2 has charged the second capacitor C2 to a voltage greater than that of the cell voltage. In this situation, when the first and second capacitors C1 and C2 are coupled together and their voltages are equalized, charge and energy flow from the second capacitor C2 to the first capacitor C1. In that situation, the voltage on the first capacitor C1 is greater than that of the cell voltage, and energy and charge will flow from the first capacitor C1 to Cell 5, charging Cell 5. The level shifter shifts a ground-referenced voltage, expressed across the second capacitor C2 as charged by the charging device, to the higher voltage level of the stacked Cell 5, for charging Cell 5. Since this level shifter can transfer energy and charge in two opposing directions, the level shifter is referred to as bidirectional.

The battery management apparatus of FIG. 2 thus has passive cell balancing, via one direction of the level shifter and the discharge device. The battery management apparatus of FIG. 2 also has active cell balancing, via the charging device in an opposing direction of the level shifter. A balance resistor R5 coupled between the level shifter and the discharge device smooths current surge and protects the discharge device from an overcurrent condition, which could damage the discharge device. The balance resistor R5 is also coupled between the level shifter and the charging device, as a result of the charging device and the discharge device being coupled to one end of the balance resistor R5. The resistor R5 smooths current surge from the charging device, and protects the charging device from an overcurrent condition, which could damage the charging device. In the embodiment shown in FIG. 2, the transistor 202 coupling the discharge device can be implemented by a switch, in this case an N type MOSFET coupled to a local or system ground. The transistor 204 coupling the charging device can be implemented by a switch, in this case a P type MOSFET coupled to a local or system power supply. In one version, the power supply also supplies the voltage measurement device 102, and is derived or developed from a connection to the battery stack. Here, active balancing of Cell 5 would route energy and current from the battery stack to Cell 5 as an embodiment of battery-to-cell active balancing. Cell voltage can be measured by the voltage measurement device 102, with the discharge device and the charging device deactivated, i.e., the switches open or the transistors 202 and 204 turned off. It should be appreciated that the charge and discharge devices may be implemented through alternative devices from the devices illustrated in FIG. 2, as the charge and discharge devices are illustrative and not meant to be limiting. That is, charge and discharge devices suitable for performing the charge and discharge functions may be interchanged with the devices illustrated in FIG. 2. In addition, transistors 202 and 204 are not meant to be limiting as other switches may be utilized with the embodiments to achieve the functionality described herein.

Capacitance and ratios of the capacitances of the two capacitors C1 and C2 can be varied or adjusted in embodiments, in order to tune the rates of charging and discharging or the rate of convergence to a cell voltage for measurement purposes. For instance, providing the second capacitor C2 to have a lower capacitance than the first capacitor C1 will require fewer iterations of the couplings and de-couplings of the capacitors in order for an accurate measurement of the cell voltage to occur by measuring the voltage across the second capacitor C2. However, this will slow the discharge rate, or equivalently decrease the time-averaged discharge current, as less charge is available on the second capacitor C2 for discharging via the resistor R5 and the discharge device 202 during each cycle of the non-overlapping clocks. This would also slow the charging rate of Cell 5, as less charge is available from a charged but lower capacitance second capacitor C2 for transfer to the first capacitor C1 and thence to Cell 5. On the other hand, making the second capacitor C2 have a greater capacitance than the first capacitor C1 will increase the charging rate of Cell 5 for a given size of the first capacitor C1, as more charge is available from a charged and higher capacitance second capacitor C2 for transfer to the first capacitor C1 and thence to Cell 5. This would also increase the discharge rate, as a greater proportion of the charge would be transferred from the first capacitor C1 to the second capacitor C2 with each cycle of the clocks. However, the length of time and the number of cycles of the clocks that would produce a measured voltage across the second capacitor C2 closely approximating the cell voltage would increase. In one embodiment, the first and second capacitors C1 and C2 have approximately equal capacitance. Another adjustment that can be made is whether to operate the discharge device through transistor 202 or the charging device through transistor 204 continuously or timed with the clocks. For example, the gate of transistors 202 and/or 204 may be controlled to achieve the desired operation mode. Operating the discharge device or the charging device continuously active (in discharging mode or charging mode, respectively) will increase the discharging rate or the charging rate as both capacitors C1 and C2 are discharging or charging when the second pair of switches (S2a and S2b) is closed. In this case, the second capacitor C2 can be thought of as acting as a reservoir of charge, either from Cell 5 or the charging device, and the first capacitor C1 can be thought of as the primary agent of charge transfer in the specified direction. The first capacitor C1 is being charged by Cell 5 and discharged by the discharge device, or is being charged by the charging device 204 and partially discharged by Cell 5. On the other hand, timing the discharge device or the charging device to be active only when the second pair of switches S2a and S2b is deactivated or open, slows the discharging rate or the charging rate as only the second capacitor C2 is being directly discharged by the discharge device or directly charged by the charging device.

The discharge devices operate at different voltage ranges in the embodiments of FIGS. 1 and 2. In FIG. 1, activating the N type MOSFET that implements the switch S5 requires a gate voltage (on the signal Enable 5) that exceeds the voltage on the negative terminal of Cell 5 by more than a threshold voltage of the MOSFET. In other words, the gate voltage for this MOSFET is up near the voltage of the positive terminal of the battery stack, which could require either components that can withstand high voltages, or level shifting, in this embodiment. For example, in a battery stack with 4 V per cell and five cells, this gate voltage might need to be near 20 V relative to ground. On the other hand, in FIG. 2, activating the discharge device through transistor 202 that is implemented as an N type MOSFET, requires a gate voltage (on the signal Discharge) that exceeds the local ground by more than a threshold voltage of the MOSFET. In other words, the gate voltage for this MOSFET would not require components that can withstand high voltages and would not require level shifting, in this embodiment. For example, even with a 20 V battery stack, the gate voltage for this MOSFET might need to be only 3 V or 5 V to activate the discharge device 202.

FIG. 3 shows a variation of the battery management apparatus of FIG. 2. Here, the discharge device 202 and the charging device 204 are moved to the inside of a controller 302. For example, the controller 302 could be a commercially available microcontroller, which includes microprocessors and programmable logic devices, with a configurable I/O (input output) port. As shown, the controller 302 also includes an analog to digital converter 304. In further embodiments, the analog-to-digital converter 304 is on a separate chip or board from the controller 302, or the controller is implemented as a board and includes the analog-to-digital converter although on a separate chip, etc. The configurable I/O port on many commercially available controllers has an output driver with a P type MOSFET as a pullup transistor coupled to a power supply, and an N type MOSFET as a pulldown transistor, coupled to ground. The pullup and the pulldown can be deactivated, leaving the port in a high impedance state, i.e., with both transistors off or deactivated. Thus, the configurable I/O port can be driving out a logical one, with a pullup activated, can be driving out a logical zero, with a pulldown activated, or can be in a high impedance state with both the pullup and the pulldown deactivated. By employing the configurable I/O port in the battery management apparatus of FIG. 3, the pulldown transistor 202 of the I/O port is used with the discharge device. The pullup transistor 204 of the I/O port is used with the charging device. It should be appreciated that this configuration decreases the number of discrete components used in a battery management apparatus, particularly when the repetition of the circuitry for each cell in a battery stack is considered.

There are three modes in which the battery management apparatus of FIGS. 2 and 3 can be operated in some embodiments. In cell voltage measuring mode, the charging and discharging actions are turned off, by deactivating transistor 202 of the discharge device and deactivating transistor 204 of the charging device. In cell discharging mode, the discharge device is activated, with the charging device being deactivated through manipulation of respective transistors or switches. In cell charging mode, the charging device is activated, with the discharging device being deactivated through manipulation of respective transistors or switches. It should be appreciated that while FIGS. 2 and 3 illustrate components for cell 5 of the battery management apparatus for ease of illustration, cells 1-4 are similarly configured. That is, the switched capacitor level shifter and the charge/discharge devices for active balancing are provided for each terminal pair across cells 1-5 in some embodiments.

In FIGS. 4A-4D, methods of managing a battery are shown in the flow diagrams. Further methods are readily devised from variations of this method and from the teachings regarding the apparatus embodiments above. To operate the switched capacitor level shifter as illustrated in FIG. 4A, the first capacitor is coupled to a cell in a battery stack, in an action 402. This is accomplished in the embodiments of FIGS. 2 and 3 by activating or closing the first pair of switches as controlled by the active phase of CLK_1. The second pair of switches remain deactivated or opened as controlled by CLK_2 being in an inactive phase. Next, the first capacitor is decoupled from the cell, in an action 404, while second pair of switches remains deactivated or opened from a previous operation. This is brought about by the non-overlap portion of the clock timing after the active phase of CLK_1. Next, the voltage is equalized across the first and second capacitors, in an action 406. This is accomplished in the embodiments of FIGS. 2 and 3 by activating or closing the second pair of switches as controlled by the active phase of CLK_2, while the first pair of switches remains deactivated or opened as controlled by CLK_1 being in an inactive phase. Next, the first and second capacitors are decoupled, in an action 408. This is brought about by the non-overlap portion of the clock timing after the active phase of CLK_2. These actions are repeated in a loop, with the action 402 following the action 408.

To operate the battery management apparatus of FIGS. 2 and 3 in cell voltage measuring mode 410 of FIG. 4B, a voltage measuring device is coupled to the second capacitor in an action 412. In these embodiments, the voltage measurement device is coupled to capacitor C2 via the resistor R5 with reference to FIG. 2 or 3. One end of the resistor R5 couples to the upper terminal of capacitor C2, while the other end of resistor R5 couples to port B5 of the voltage measurement device (in FIG. 2) or of the controller (in FIG. 3). The voltage across the second capacitor is measured, in an action 414. For example, this is accomplished by applying the analog-to-digital converter to measure the voltage at the port B5, with the discharge device deactivated and the charging device deactivated, so that there is essentially no current through the resistor R5, and therefore no voltage drop across the resistor R5. Typically, the resistor R5 has a relatively low resistance and would not introduce much error during voltage measurement even if a small current were present. Under these conditions, the voltage measurement device accurately measures the voltage across capacitor C2, which is referenced to a local ground. The switched capacitor level shifter rejects common mode noise, defined as a voltage relative to system ground that is common to both terminals of a cell in the battery stack.

To operate the battery management apparatus of FIGS. 2 and 3 in cell discharging mode 416 of FIG. 4C, charge is transferred from a cell to the first capacitor C1, in an action 418. This is accomplished in these embodiments by closing or activating the first pair of switches coupling capacitor C1 to Cell 5, with the second pair of switches deactivated or open. Some of the charge is transferred from the first capacitor to the second capacitor, in an action 420. This is accomplished by deactivating or opening the first pair of switches, decoupling capacitor C1 from Cell 5, then activating or closing the second pair of switches and coupling the capacitors C1 and C2 to each other. Capacitor C2 (also referred to as the second capacitor) is discharged, in an action 422. This can be accomplished by activating the discharge device, i.e. closing the switch or turning on the ground-coupled transistor in an implementation of the discharge device. As discussed above, this could be done with the second pair of switches activated, which would discharge both of the capacitors C1 and C2, or with the second pair of switches deactivated, which would discharge the second capacitor C2.

To operate the battery management apparatus of FIGS. 2 and 3 in cell charging mode 424 of FIG. 4D, the second capacitor C2 is charged in an action 426. To do so, the charging device is activated, which charges up the second capacitor C2. Depending upon the length of time available for charging, the capacitance of the second capacitor C2, the resistance of the resistor R5, the “on” resistance of the charging device and other factors, the charged voltage across the second capacitor C2 will approach the power supply voltage to varying degrees. The charging device could be activated with the second pair of switches S2a, S2b deactivated or open, in which case the second capacitor C2 is charged. Alternatively, the charging device may be activated with the second pair of switches S2a, S2b activated or closed, in which case the second capacitor C2 and the first capacitor C1 are charged. Some of the charge is transferred from the second capacitor to the first capacitor, in an action 428. This can be accomplished by activating or closing the second pair of switches S2a, S2b, coupling the second capacitor C2 to the first capacitor C1, with the first pair of switches S1a, S1b deactivated or open. This charge transfer could happen with the charging device activated or deactivated. Some of the charge from the first capacitor is transferred to the cell, in an action 430. This can be accomplished by deactivating or opening the second pair of switches S2a, S2b, decoupling the first and second capacitors C1, C2, then activating or closing the first pair of switches S1a, S1b and coupling the first capacitor C1 to Cell 5. The amount of charge transferred will depend on the difference in voltages between the cell and the charged first capacitor C1 prior to coupling the first capacitor C1 to Cell 5.

The direction of power flow is determined by the voltage across the second capacitor C2 relative to the voltage across the first capacitor C1, at the moment the switches S1a and S1b close. If the voltage across the second capacitor C2 is higher than the voltage across the first capacitor C1, then the cell will charge. If the voltage across the second capacitor C2 is lower than the voltage across the first capacitor C1, then the cell will discharge.

It should be appreciated that the battery management apparatus of FIGS. 2 and 3 provide for active balancing, decreasing the drive voltage requirements for a discharge device, decreasing the number of discrete components (in FIG. 3), and supporting battery-to-cell active balancing. Variations in controls and polarities of the clocks, enables and other signals, the types of switches or transistors and so on are readily devised.

With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The embodiments can also be embodied as computer readable code on a computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A battery management apparatus, comprising:
a switched capacitor level shifter having a first port and a second port, the first port being configured to couple to a cell in a battery stack, the second port being configured to couple to a voltage measurement device; and
a discharge device coupled to the second port, wherein the discharge device is configured to discharge the cell via the switched capacitor level shifter.

2. The battery management apparatus of claim 1, further comprising:
a charging device coupled to the second port, wherein the charging device is configured to charge the cell via the switched capacitor level shifter.

3. The battery management apparatus of claim 2, wherein the discharge device and the charging device are coupled to the second port via a common resistor;
the discharge device comprises a first switch; and
the charging device comprises a second switch, wherein control of the first switch determines whether a charging or discharging operation occurs for the cell.

4. The battery management apparatus of claim 2, wherein the charging device is configured to couple to a power supply having a voltage greater than a voltage across the cell.

5. The battery management apparatus of claim 2, wherein the charging device and the switched capacitor level shifter are configured to perform battery-to-cell balancing.

6. The battery management apparatus of claim 1, wherein the first port is bi-directional and the second port is bi-directional.

7. The battery management apparatus of claim 1, wherein the switched capacitor level shifter comprises a first capacitor and a second capacitor;
the first capacitor is configured to alternate between being coupled to the first port and being coupled to the second capacitor;
the second capacitor is coupled to the second port.

8. The battery management apparatus of claim 7, wherein the switched capacitor level shifter comprises a first pair of switches and a second pair of switches, the first pair of switches controlled by a first clock signal and the second pair of switches controlled by a second clock signal, wherein the first clock signal and the second clock signal are non-overlapping signals.

9. A battery management apparatus, comprising:
a bi-directional, switched capacitor level shifter configured to couple a first end of the switched capacitor level shifter to one of a plurality of cells in a battery stack;
a voltage measurement device coupled to a second end of the switched capacitor level shifter;
a pullup switch coupled to the second end of the switched capacitor level shifter; and
a pulldown switch coupled to the second end of the switched capacitor level shifter.

10. The battery management apparatus of claim 9, wherein the pullup switch and the pulldown switch are coupled to the second end of the switched capacitor level shifter by a shared load resistor, the pullup switch is coupled to the second end via a first MOSFET (metal oxide semiconductor field effect transistor), and the pulldown switch is coupled to the second end via a second MOSFET, wherein the first MOSFET is a p-type MOSFET and the second MOSFET is an n-type MOSFET.

11. The battery management apparatus of claim 9, wherein the bidirectional, switched capacitor level shifter comprises:
a first capacitor;
a second capacitor;
a first switch coupled to a first terminal of the first capacitor and configured to couple to a first terminal of the one of the plurality of cells;
a second switch coupled to the first terminal of the first capacitor and coupled to a first terminal of the second capacitor;
a third switch coupled to a second terminal of the first capacitor and configured to couple to a second terminal of the one of the plurality of cells; and
a fourth switch coupled to the second terminal of the first capacitor and coupled to a second terminal of the second capacitor.

12. The battery management apparatus of claim 9, further comprising:
a nonoverlapping clock generator coupled to the bidirectional, switched capacitor level shifter.

13. The battery management apparatus of claim 9, wherein the pullup switch and the pulldown switch are included in an I/O (input output) port of a controller.

14. The battery management apparatus of claim 9, wherein the voltage measurement device includes an analog to digital converter and wherein the voltage measurement device is included in a controller.

15. The battery management apparatus of claim 9, wherein the bidirectional, switched capacitor level shifter and the pulldown switch are configured to perform passive cell balancing, and wherein the bidirectional, switched capacitor level shifter and the pullup switch are configured to perform active cell balancing.

16. A method of managing a battery stack, comprising:
coupling a first capacitor to one of a plurality of cells in the battery stack, with a second capacitor decoupled from the first capacitor;
decoupling the first capacitor from the one of the plurality of cells;
coupling the second capacitor to the first capacitor, with the first capacitor decoupled from the one of the plurality of cells;
decoupling the second capacitor from the first capacitor;
measuring a voltage of the second capacitor, in a cell voltage measuring mode; and
discharging the second capacitor, in a cell discharging mode.

17. The method of claim 16, further comprising:
charging the second capacitor, in a cell charging mode.

18. The method of claim 17, further comprising:
coupling an I/O (input output) port to the second capacitor;
operating the I/O port as an input, in the cell voltage measuring mode, wherein the I/O port includes an analog input;
driving the I/O port as an output having a logical one, in the cell charging mode; and
operating the I/O port as an output having a logical zero, in the cell discharging mode.

19. The method of claim 16, further comprising:
balancing the one of the plurality of cells via the second capacitor and the first capacitor.

20. The method of claim 16, wherein the voltage of the second capacitor is measured after iterative couplings and decouplings of the first and second capacitors.
